(19) United States
(12) Patent Application Publication
(10) Pub. No.: US 2018/0161228 A1
(43) Pub. Date: Jun. 14, 2018

(54) ABDOMINAL THRUST DEVICE

(71) Applicants: HSIAO-HUNG CHIANG, New Taipei (TW); LI-CHI CHU, New Taipei (TW)

(72) Inventors: HSIAO-HUNG CHIANG, New Taipei (TW); LI-CHI CHU, New Taipei (TW)

(21) Appl. No.: 15/376,660

(22) Filed: Dec. 13, 2016

(51) Int. Cl. A61H 1/00; A61H 11/00

(52) U.S. Cl. CPC A61H 1/008; A61H 2205/083; A61H 11/00

(57) ABSTRACT

An abdominal thrust device comprises a belt, a track assembly, a thrusting assembly, and a controller. The belt is detachably worn at abdomen of a human body. The track assembly is rounded and arranged at an inner surface of the belt corresponding to large intestine or small intestines of the human body. The thrusting assembly is movably engaged with the track assembly and moved along the track assembly cyclically to thrust the large intestine or the small intestines of the human body. The controller wirelessly or wired controls the thrusting assembly to operate or not.

### FIELD OF THE INVENTION

The present invention relates to a thrusting device, and more particularly to an abdominal thrust device.

### BACKGROUND OF THE INVENTION

Nowadays, people are working under great stress, messing up their sleep schedule, and abnormal diet to result in the problems of the digestive system, such as constipation.

The way to resolve the problem of constipation now is mainly by controlling diet or medication, but there is no Physical Therapy or massaging device to treat the digestive system directly.

The method for resolving the problem of constipation recently by diet or medicine is not effective and may be harmful to the health.

Furthermore, the conventional abdominal message device massages the abdomen of the human body by vibration, but not thrusts the acupuncture points of the abdomen (large intestine or small intestines) of the human body directly. Therefore, to resolve the problem of constipation is ineffective.

In view of the foregoing circumstances, the inventor has invested a lot of time to study the relevant knowledge, compare the pros and cons, research and develop related products. After quite many expetireents and tests, the “abdominal thrust device” of this invention is eventually launched to improve the foregoing shortcomings, to meet the public use.

### SUMMARY OF THE INVENTION

An object of this invention is providing an abdominal thrust device. The structure of the abdomen device is simplified. The thrusting assembly is slowly clockwise moved along the rounded track assembly and each finger member (just like the finger of the human body) may slowly thrust the abdomen (large intestine or small intestines) of the human body. And further the dried and hardened feces in abdomen (large intestine or small intestines) of the human body may be removed to improve metabolism and keep healthy.

To achieve above objects, an abdominal thrust device may comprise a belt, detachably worn at abdomen of a human body; a track assembly, being rounded and arranged at an inner surface of the belt corresponding to large intestine or small intestines of the human body; a thrusting assembly, movably engaged with the track assembly, the thrusting assembly is moved along the track assembly cyclically to thrust the large intestine or the small intestines of the human body; and a controller, wirelessly or wired controlling the thrusting assembly to operate or not.

In some embodiments, the track assembly has two tracks.

In some embodiments, the thrusting assembly has a body, two protruding members, and a plurality of finger members, the two protruding members are spaced apart from each other, convexly arranged at one side surface of the body, and respectively engaged with the two tracks, the finger members are detachably arranged at one side surface of the body opposite to the two protruding members.

In some embodiments, the track assembly further has a driving member, the driving member is electrically connected with the controller to drive the thrusting assembly to move along the two tracks.

In some embodiments, the driving member is in the manner of gear driving or magnetic driving.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is a partial exploded view of an abdominal thrust device of the present invention.

FIG. 2 is a perspective view of inside of the abdominal thrust device of the present invention.

FIG. 3 is a perspective view of outside of the abdominal thrust device of the present invention.

FIG. 4 is a partial enlarged view of a thrusting assembly and a track assembly of the abdominal thrust device of the present invention.

FIG. 5 is an exploded view of the thrusting assembly of the abdominal thrust device of the present invention.

FIG. 6 is a perspective view of the thrusting assembly of the abdominal thrust device of the present invention.

FIG. 7 is a perspective view of the finger members of the thrusting assembly which is shorter than the finger members shown in FIG. 6.

FIG. 8 is a perspective view of the finger members of the thrusting assembly which is shorter than the finger members shown in FIG. 7.

FIG. 9 is a cross-sectional view of the thrusting assembly of the abdominal thrust device of the present invention.

FIG. 10 is a plan view of outside of the abdominal thrust device of the present invention.

FIG. 11 is a view of the abdominal thrust device of the present invention while being worn at abdomen of a human body.

FIG. 12 is a block diagram of the structure of the abdominal thrust device of the present invention.

### DESCRIPTION OF THE PREFERRED EMBODIMENT

Referring now to the drawings where like characteristics and features among the various figures are denoted by like reference characters.

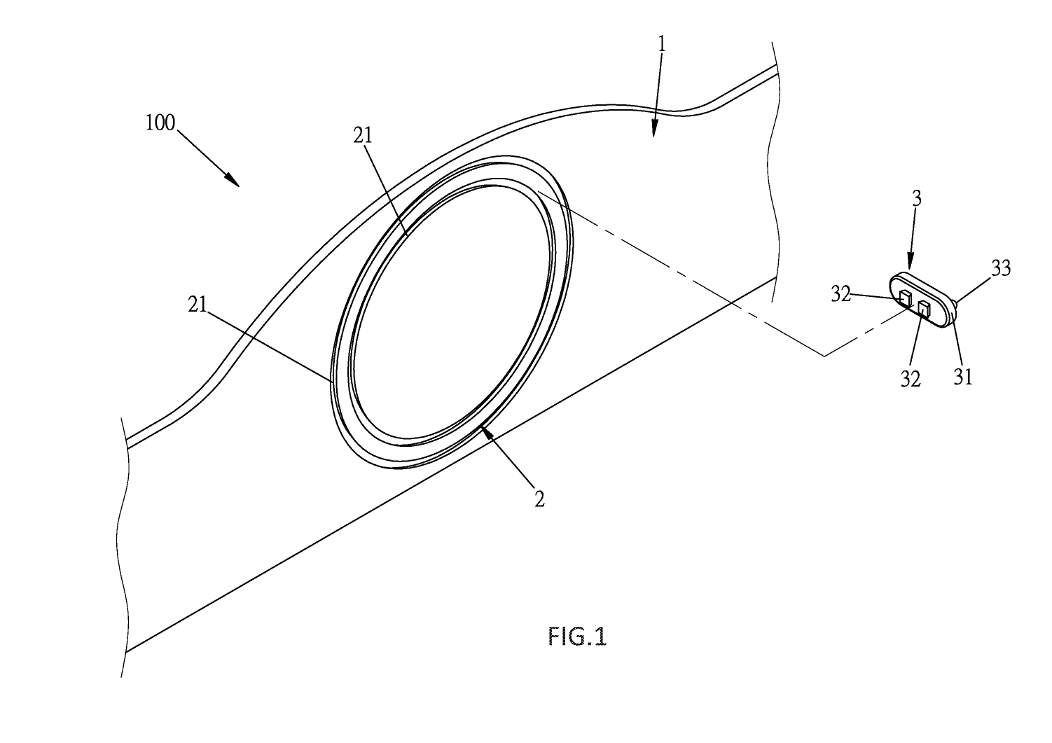

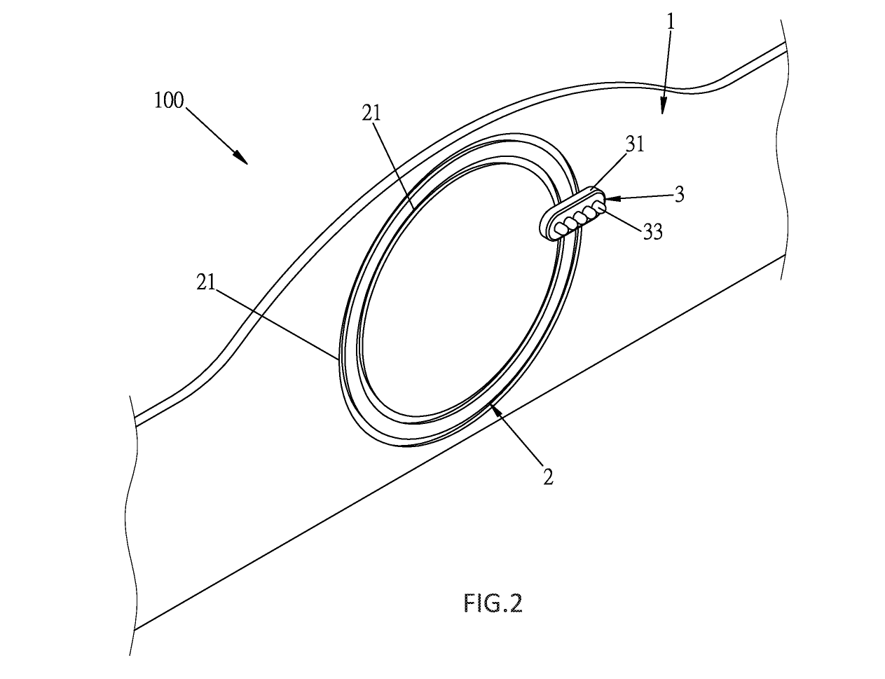

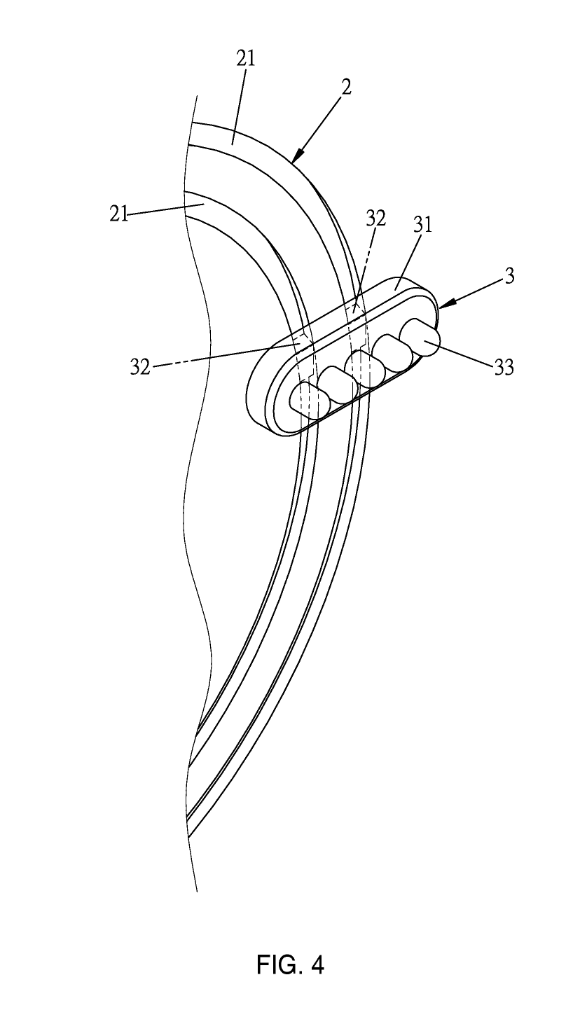

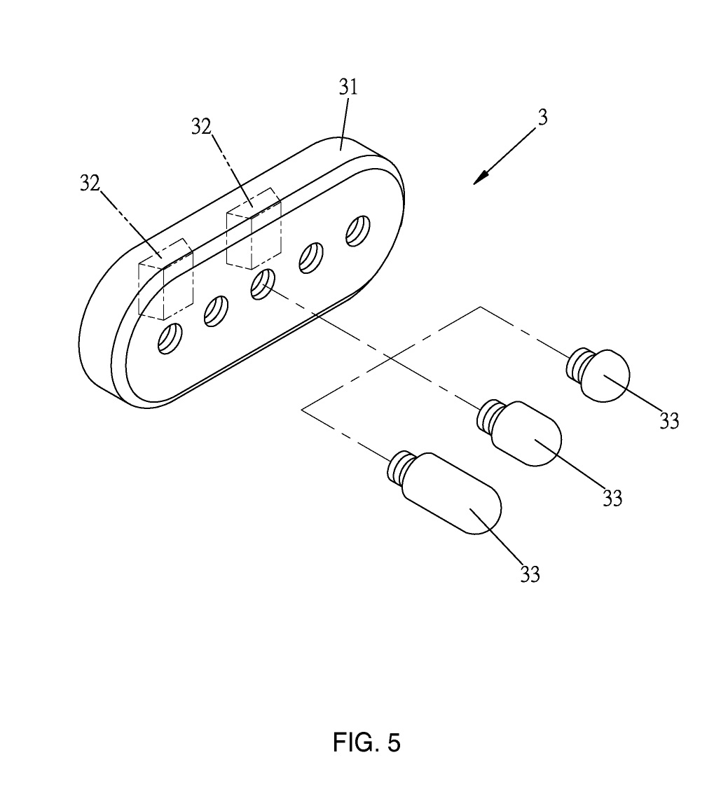

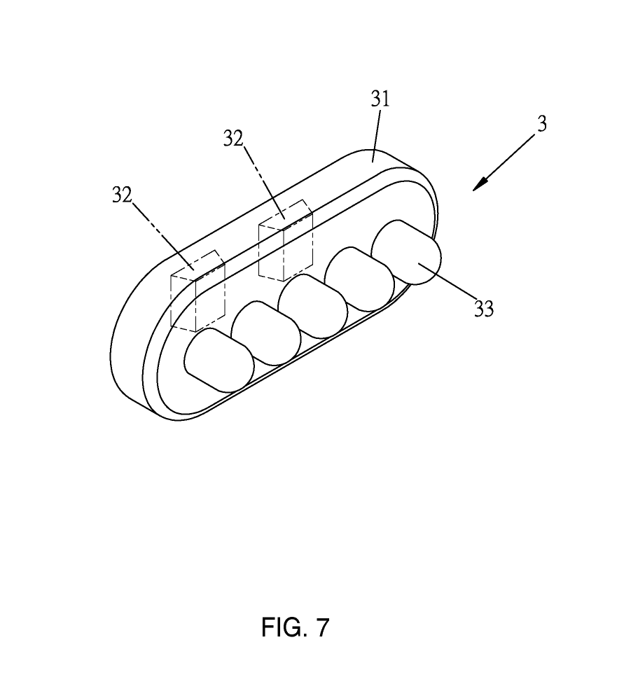

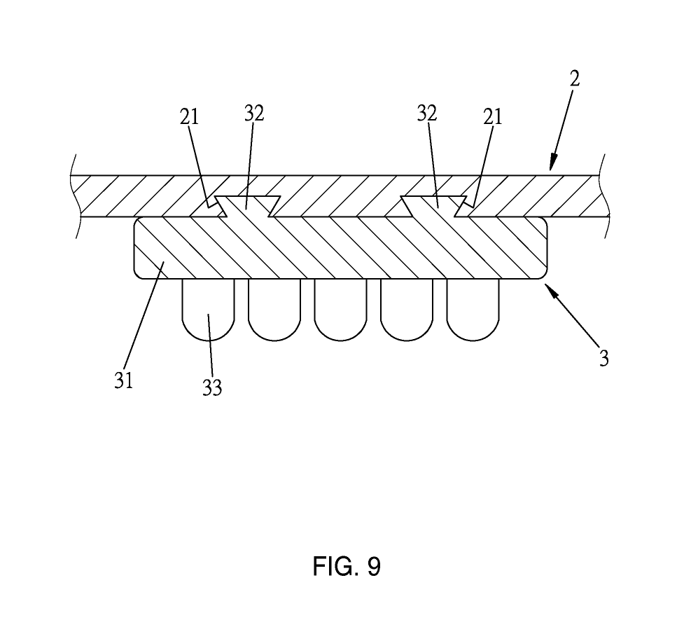

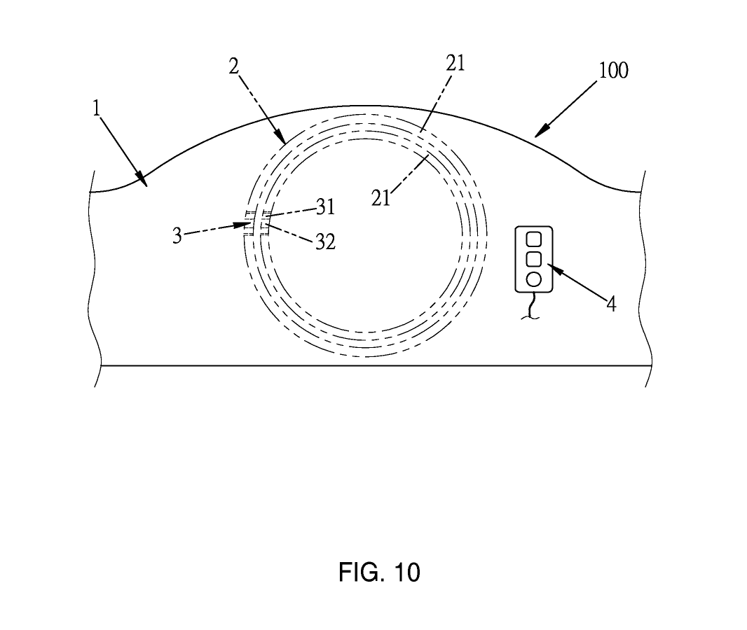

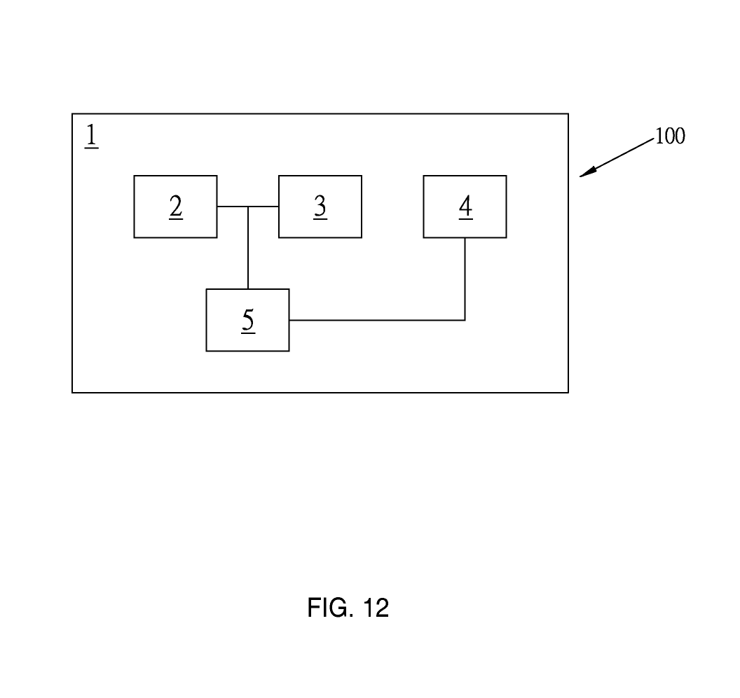

Please refer to FIGS. 1 to 12, an abdominal thrust device of the present invention may comprise a belt 1, a track assembly 2, a thrusting assembly 3, and a controller 4.

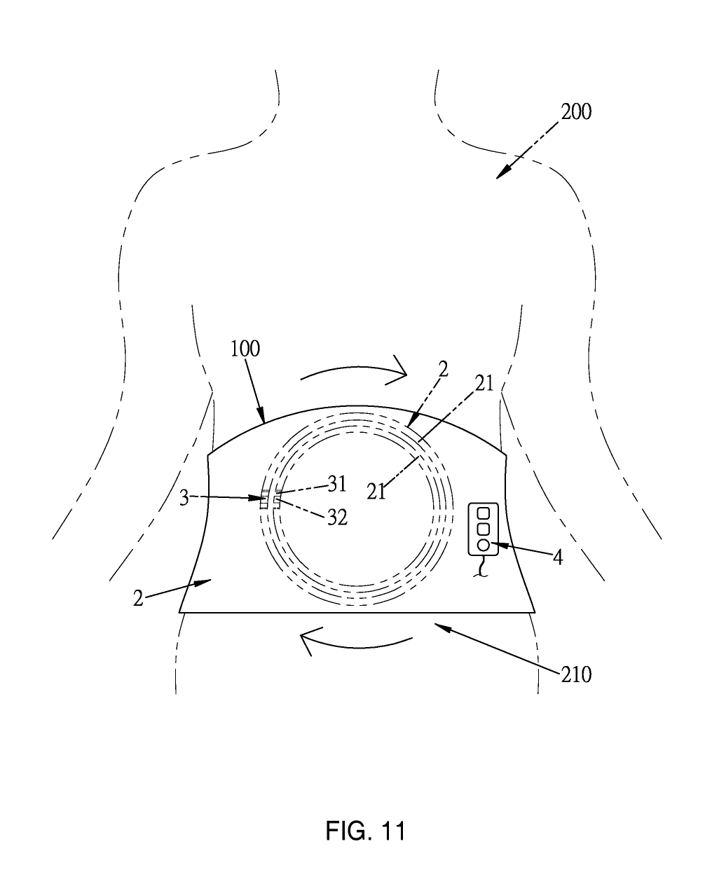

The belt 1 may be detachably worn at abdomen 210 (shown as in FIG. 11) of a human body 200.

The track assembly 2 is rounded and arranged at an inner surface of the belt 1 which corresponds to abdomen 210 (large intestine or small intestines) of the human body 200.

The thrusting assembly 3 may be movably engaged with the track assembly 2. The thrusting assembly 3 is moved along the track assembly 2 cyclically to thrust the abdomen 210 (large intestine or small intestines) of the human body 200.

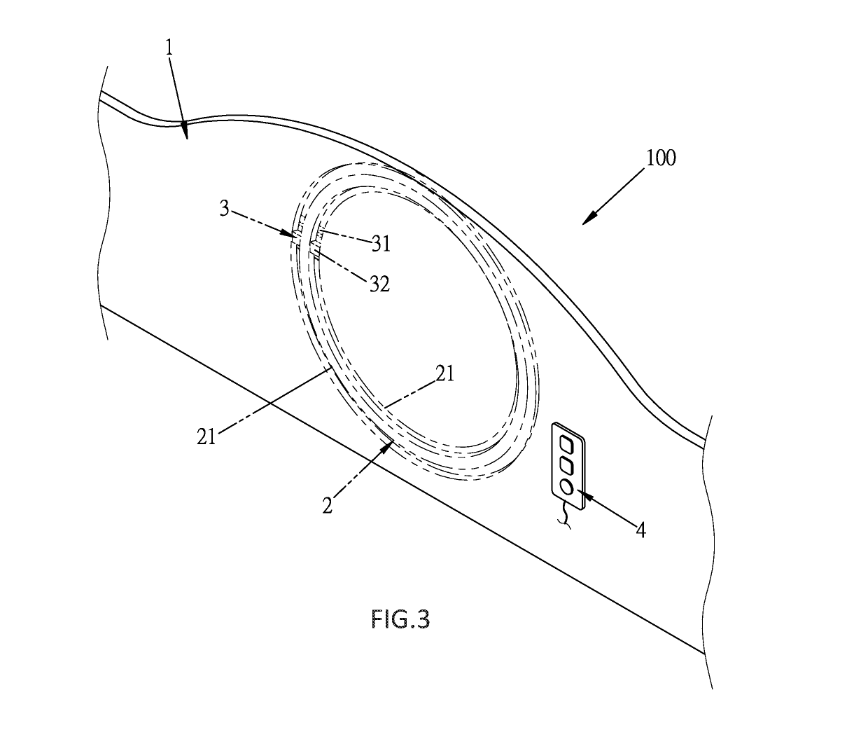

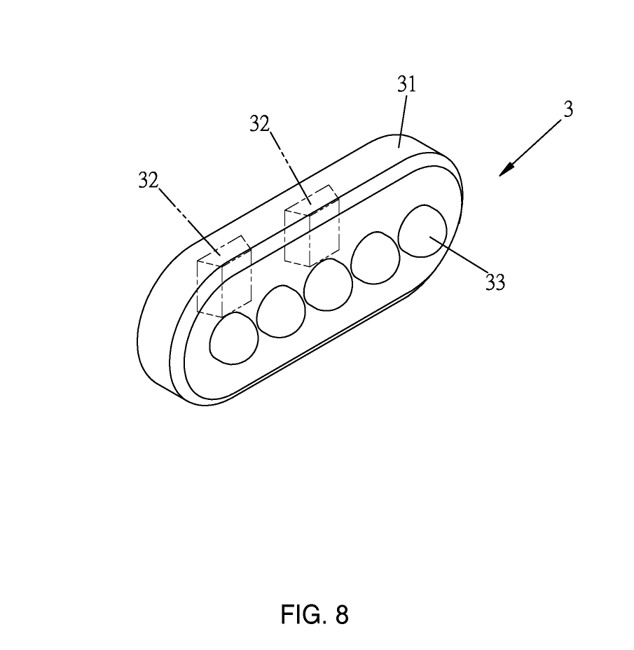

The controller 4 may be a diverter switch or control switch. The controller 4 may wirelessly or wired control the thrusting assembly 3 to operate or not. If the controller 4 wirelessly controls the thrusting assembly 3, the controller 4 is arranged at an outer surface of the belt 1 (shown as in FIGS. 3 and 8). If the controller 4 wired controls the thrusting assembly 3, the controller 4 is a remote controller.

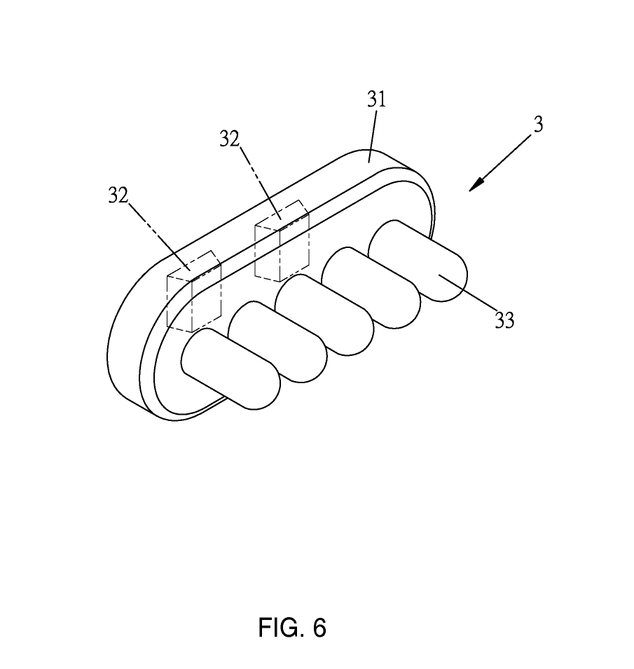

The track assembly 2 may have two tracks 21. The thrusting assembly 3 has a body 31, two protruding members 32, and a plurality of finger members 33. In this embodiment, there are four finger members for illustration, but not limited thereto. The two protruding members 32 are spaced apart from each other, convexly arranged at one side surface of the body 31, and respectively engaged with the two tracks 21. The finger members 33 are detachably arranged at one side surface of the body 31 which is opposite to the two protruding members 32. Each of the finger members 33 may be replaced by one with different length (shown as in FIGS. 6, 7, and 8). Therefore, the two protruding members 32 are respectively engaged with the two tracks 32 so that the thrusting assembly 3 may firmly move along the track assembly 2.

The thrusting assembly 3 is moved along the track assembly 2 by a driving member 2. The driving member 5 may be arranged at the track assembly 2 or the thrusting assembly 3. And the movement of the driving member 5 may be performed by the manners of gear driving (mechanically) or magnetic driving (magnetically).

According to above mentioned structure, the structure of the abdominal thrust device 100 is simplified. The thrusting assembly 3 is slowly clockwise moved along the rounded track assembly 2 and each finger member 33 (just like the finger of the human body) may slowly thrust the abdomen 210 (large intestine or small intestines) of the human body 200. And further the dried and hardened feces in abdomen 210 (large intestine or small intestines) of the human body 200 may be removed to improve metabolism and keep healthy.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. An abdominal thrust device, comprising:
a belt, detachably worn at abdomen of a human body;
a track assembly, being rounded and arranged at an inner surface of the belt corresponding to large intestine or small intestines of the human body;
a thrusting assembly, movably engaged with the track assembly, the thrusting assembly is moved along the track assembly cyclically to thrust the large intestine or the small intestines of the human body; and
a controller, wirelessly or wired controlling the thrusting assembly to operate or not.

2. The abdominal thrust device as claimed in claim 1, wherein the track assembly has two tracks.

3. The abdominal thrust device as claimed in claim 2, wherein the thrusting assembly has a body, two protruding members, and a plurality of finger members, the two protruding members are spaced apart from each other, convexly arranged at one side surface of the body, and respectively engaged with the two tracks, the finger members are detachably arranged at one side surface of the body opposite to the two protruding members.

4. The abdominal thrust device as claimed in claim 2, wherein the track assembly further has a driving member, the driving member is electrically connected with the controller to drive the thrusting assembly to move along the two tracks.

5. The abdominal thrust device as claimed in claim 3, wherein the track assembly further has a driving member, the driving member is electrically connected with the controller to drive the thrusting assembly to move along the two tracks.

6. The abdominal thrust device as claimed in claim 4, wherein the driving member is in the manner of gear driving or magnetic driving.

7. The abdominal thrust device as claimed in claim 5, wherein the driving member is in the manner of gear driving or magnetic driving.
